(19) United States
(12) Patent Application Publication
(10) Pub. No.: US 2013/0188168 A1
(43) Pub. Date: Jul. 25, 2013

(54) FIBER OPTIC FORMATION DIMENSIONAL CHANGE MONITORING

(71) Applicants: Arthur H. Hartog, Winchester (GB); Barry Read, Bournemouth (GB)

(72) Inventors: Arthur H. Hartog, Winchester (GB); Barry Read, Bournemouth (GB)

(21) Appl. No.: 13/354,629

(22) Filed: Jan. 20, 2012

(51) Int. Cl. G01B 11/02; G01B 11/16

(52) U.S. Cl. 356/32; 356/634; 356/72

(57) ABSTRACT

Fiber optic monitoring of dimensional changes within a subterranean formation includes deploying a fiber optic cable assembly in a wellbore and attaching the cable assembly to first and second attachment points on either side of the formation. A surface fiber optic measurement system measures changes in the optical path length between the attachment points of the fiber optic cable assembly. The changes in optical path length are directly indicative of dimensional changes within the formation.

### BACKGROUND

Hydrocarbon fluids, such as oil and natural gas, are obtained from a subterranean geologic formation, referred to as a reservoir, by drilling a well that penetrates the hydrocarbon-bearing formation. Once a wellbore is drilled, various well completion components may be installed to control and enhance the efficiency of producing the various fluids from the reservoir. However, the production of hydrocarbon fluids from the reservoir can result in dimensional changes of the formation. In some instances, the dimensional changes are due to compaction and subsidence. In other instances, the reservoir may experience thermal expansion, for example where heating (such as with steam) is used in enhanced oil recovery methods. In either case, dimensional changes can lead to fracturing of the hydrocarbon-bearing formations and surface deformations, both of which can affect the stability of surface installations.

### BRIEF DESCRIPTION OF THE DRAWINGS

Certain embodiments of the invention are described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current invention.

FIG. 1 is a flow diagram of an exemplary technique for monitoring dimensional changes within a subterranean formation using a fiber optic measurement system, according to an embodiment.

FIG. 2 is a schematic illustration of an exemplary fiber optic formation dimensional change monitoring system deployed in a wellbore, according to an embodiment.

FIG. 3 is a schematic illustration of an exemplary fiber optic sensor cable assembly for deployment in a wellbore, according to an embodiment.

FIG. 4 is a schematic illustration of another exemplary fiber optic formation dimensional change monitoring system deployed in a wellbore, according to an embodiment.

FIG. 5 is a block diagram of exemplary circuitry to measure dimensional changes within a formation, according to an embodiment.

FIG. 6 is a schematic illustration of an exemplary fiber optic sensor cable assembly that can be used with the circuitry of FIG. 5, according to an embodiment.

FIG. 7 is a schematic illustration of another exemplary fiber optic sensor cable assembly that can be used with the circuitry of FIG. 5, according to an embodiment.

FIG. 8 is a block diagram of exemplary fiber optic surface instrumentation system to measure a strain profile of an optical fiber, according to an embodiment.

FIG. 9 is a block diagram of another exemplary fiber optic surface instrumentation system to measure a strain profile of an optical fiber, according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention.

Available techniques that can be used to monitor dimensional changes of a formation either do not provide for direct monitoring of dimensional changes of the formation itself, do not result in accurate measurements of dimensional changes, and/or cannot withstand the elevated formation temperatures that result when enhanced recovery techniques are employed. As examples, conventional surface surveying techniques (e.g., theodolite based or synthetic-aperture radar satellite techniques) can provide some indication of surface changes that may be a result of dimensional changes of a subterranean formation. However, observation of surface changes provides only an indirect means for monitoring dimensional changes of the formation itself. While known microseismic monitoring techniques may provide an indication of the location of fracturing and fault activation, these techniques also cannot provide a direct measurement of dimensional changes of the formation. Likewise, methods of measuring deformation of the well casing cannot provide a direct assessment of the dimensional changes of the formation. Active seismic monitoring can provide a general image of the reservoir, but lacks the accuracy desired for monitoring dimensional changes of the formation. Electrical monitoring techniques are not suitable for monitoring dimensional changes of the formation as they are unable to withstand the elevated temperatures reached by the reservoir when production is stimulated by heat.

Accordingly, various embodiments of the invention comprise methods and apparatus that directly monitor dimensional changes of a reservoir, such as compaction and/or swelling of the hydrocarbon-bearing formation. The methods and apparatus employ fiber optic measurement techniques to monitor dimensional changes within the formation and, thus, are able to withstand the harsh conditions present in the subterranean environment. In general, in various embodiments, a fiber optic cable assembly is lowered into a wellbore that penetrates a hydrocarbon-bearing formation of interest. The cable assembly has at least two reference points, one of which is attached or connected to the open wellbore wall (such as to the rock or other subterranean material) at a first reference point relative to the formation (e.g., above the formation) and the other of which is attached to the wellbore wall at a second reference point relative to the formation (e.g., below the formation) so that the cable assembly extends across the formation or portion of the formation of interest. Changes in the optical path length between the two reference points can then be measured from the surface using any of a variety of fiber optic monitoring techniques (as will be described in further detail below). These measurements provide a direct indication of dimensional changes within the formation of interest, including compaction and/or swelling.

In some embodiments, the temperature distribution or average temperature is also measured along the optical path between the two reference points using various fiber optic measurement techniques (as will be described in further detail below). The measurement of the changes in optical path length can then be corrected to compensate for temperature changes between the reference points. The corrected optical path length can be used to determine changes in distance between the optical assembly attachment locations on the wellbore wall on either side of the formation of interest and, thus, dimensional changes of the formation itself.

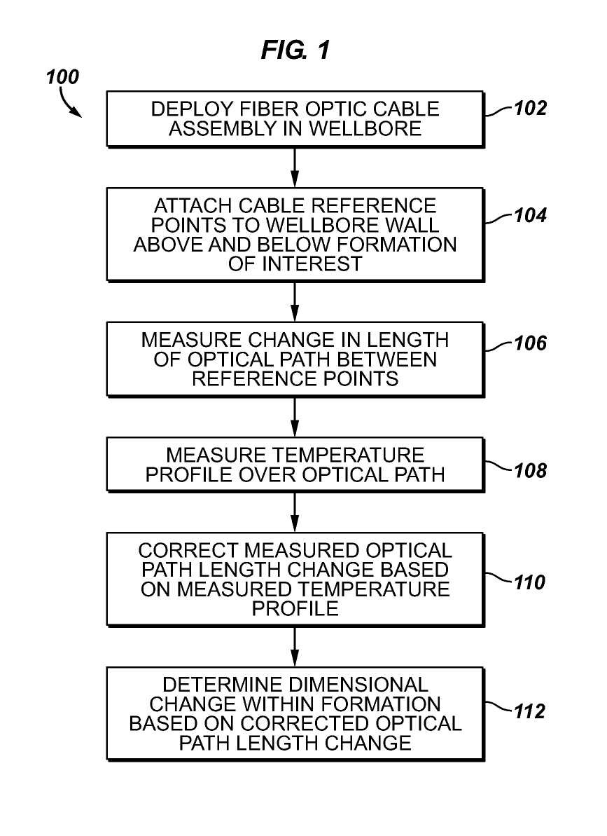

FIG. 1 is a flow chart illustrating an exemplary technique 100 for directly monitoring dimensional changes of a hydrocarbon-bearing formation. As illustrated in FIG. 1, a fiber optic cable assembly is deployed in a wellbore that has been drilled through a formation of interest (block 102). The fiber optic cable assembly has at least two reference points that are attached, fixed or connected to corresponding attachment points along the open wellbore wall on either side of a formation of interest (block 104). Changes in optical path length between the reference points of the fiber optic cable assembly are measured (block 106). In various embodiments, tension (and thus strain) is applied to the cable assembly prior to attachment to the attachment points, particularly if compaction of the formation is expected. In this manner, shrinkage, as well as elongation, of the distance between the reference points can be measured. In some embodiments, the distribution of temperature along the optical path between the two reference points also is measured (block 108). The temperature distribution measurement can then be used to correct the measurement of the change of optical path length to compensate for a temperature change over the section of the fiber optic cable assembly between the reference points (block 110). A dimensional change within the formation of interest (e.g., a change in thickness due to compaction and/or swelling) can then be determined based on the corrected optical path length change (block 112).

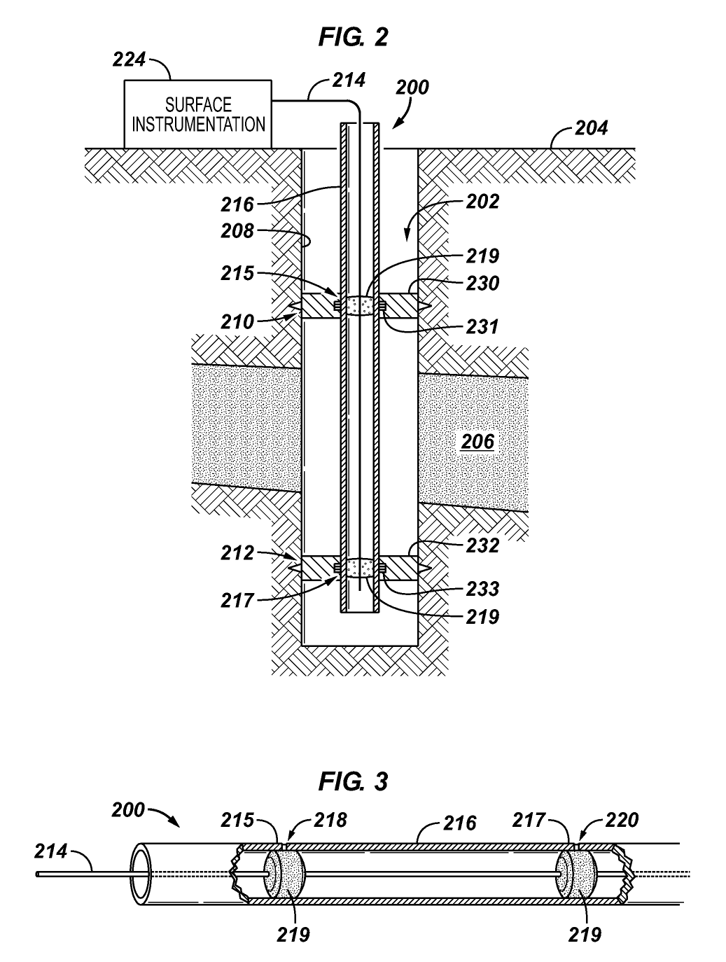

FIG. 2 is a schematic illustration of an exemplary implementation where a fiber optical cable assembly 200 has been deployed in an open wellbore 202 that extends from the earth surface 204 through a formation of interest 206. As shown in FIG. 2, the cable assembly 200 extends across the formation 206 and has a first reference point 215 that is attached to the open wellbore wall 208 at a first attachment point 210 located above the formation 206 and a second reference point 217 that is attached to the wall 208 at a second attachment point 212 located below the formation 206. Although the attachment points 210, 212 are shown at locations that are above and below the formation 206, it should be understood that various implementations may include more than two attachment points to allow for greater resolution of the measurement of the dimensional changes within the formation 206.

With reference now to FIG. 3 in conjunction with FIG. 2, the fiber optic cable assembly 200 includes an optical fiber 214, which in some embodiments, may be protected by a casing 216, such as a control line or other tubular conduit. In such embodiments, the optical fiber 214 is attached to the wall of the conduit 216 at reference points 215, 217 which are selected based on the installation in which the assembly 200 will be deployed so that the reference points 215, 217 can be attached to attachment points 210, 212 on either side of the formation of interest 206. In embodiments in which enhanced resolution of the dimensional change profile of the formation 206 is desired, the optical fiber 214 may be attached to the wall of the conduit 216 at additional reference point locations. The optical fiber 214 can be any of variety of types of optical fibers, such as multimode optical fiber, singlemode optical fiber, polarization-maintaining or photonic crystal fiber. The type of optical fiber 214 selected for a particular implementation generally will depend on the manner in which the change in optical path length is to be measured. Various techniques for measuring optical path length will be discussed in detail below.

The attachment of the optical fiber 214 to the wall of the conduit 216 can be achieved in a variety of manners. For instance, the optical fiber 214 may be coated with a metallic coating which can then be attached to the wall of the conduit 216 by high temperature soldering. In the embodiment of FIG. 3, the optical fiber 214 is attached to the wall of the conduit 216 using an adhesive 219, such as an epoxy that is capable of withstanding the anticipated strain and temperature extremes that will be present in the environment in which the cable assembly 200 will be deployed. As an example, the tubular control line 216 can include injection ports 218, 220 at the reference points 215, 217. The injection ports 218, 220 initially are sealed so that the optical fiber 214 can be deployed in the control line 216 using known techniques, such as fluid drag. Once the fiber 214 is deployed within the control line 216, the control line 216 may be prepared for injection of the adhesive. For instance, the preparation may include cleansing of the control line 216 by passing a mild solvent through the line 216 and then drying the line 216, such as by gentle heating while purging with a dry gas. After preparation, the fiber 214 can be attached at the reference points 215, 217 along the control line by 216 unsealing the injection ports 218, 220, injecting a controlled volume of adhesive 219, re-sealing the ports 218, 220, and allowing the adhesive 219 to cure. Generally, the volume of injected adhesive is determined so that it is sufficient to ensure adequate strength of the bond based on the shear strength of the adhesive when exposed to the downhole temperature and strain extremes in the environment in which the fiber optic cable assembly 200 is to be deployed.

In other embodiments, the optical fiber 214 can be introduced within the conduit 216 using other techniques, such as by forming a metallic tube about the optical fiber 214 followed by seam-welding the metallic tube to enclose the optical fiber 214 therein. In some embodiments, the optical fiber 214 may be secured at the reference points 215, 217 along the conduit 216 using glass-metal seals or elastomeric compression joints, for example.

In various implementations of the optical fiber assembly 200, the optical fiber 214 is deployed within the conduit 216 so that it will remain under sufficient tension so that substantially no slack is present when the assembly 200 is placed in the wellbore 202. This manner of deployment of the optical fiber 214 within the control line 216 is generally referred to as “understuffing.” Alternatively, the optical fiber 214 can be deployed within the conduit 216 with a controlled length of excess optical fiber 214 that has been selected so that the optical fiber 214 can withstand and operate without damage over the range of strain to which it will be exposed in the wellbore 202. This manner of deployment within the control line 216 is generally referred to as “overstuffing.” Regardless of whether the optical fiber 214 is understuffed or overstuffed, the optical fiber 214 is deployed in the control line 216 so that a desired length of fiber 214 relative to the length of the control line 216 is maintained.

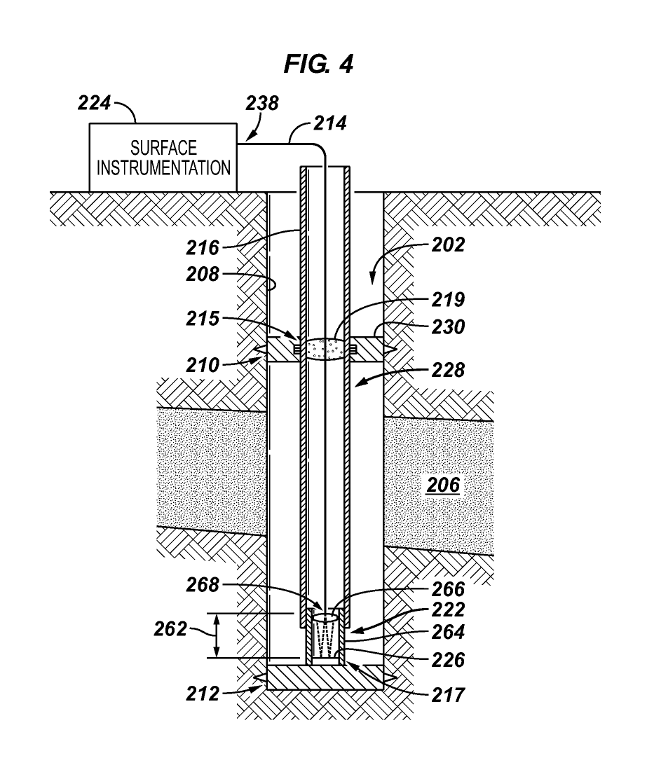

In alternative implementations of the monitoring techniques and apparatus described herein, the optical cable assembly 200 includes two separate sections that together extend across the formation 206 when the assembly 200 is deployed in the wellbore 202. For instance, with reference to FIG. 4, the cable assembly 200 can include a lower section 222 for attachment to the attachment point 212 that is below the formation of interest 206. This lower section 222 includes a reflector 226 (e.g., a mirror). The other (upper) section 228 of the cable assembly 200 is attached at the attachment point 210 along the wellbore wall 208 located above the formation of interest 206. This upper section 228 hangs under its own weight and is arranged to slide telescopically inside or outside of the lower section 222 of the cable assembly 200. The upper section 228 includes the optical fiber 214, which hangs freely. As will be explained in further detail below, the optical fiber 214 can provide information to a surface instrumentation system 224 regarding the position of the upper attachment point 210 relative to the lower attachment point 212 which is indicative of dimensional changes of the formation of interest 206.

Returning to the exemplary embodiment of FIG. 2, the cable assembly 200 is attached at the two attachment points 210, 212 along the wall 208 of the open wellbore 202, where the first point 210 is located above the formation 206 and the second point 212 is located below the formation 206. In some embodiments, the cable assembly 200 is attached to attachment points 210, 212 via retention devices 230, 232 (e.g., clamps, latches, locks, etc.). In some embodiments, the devices 230, 232 can be lowered into the wellbore 202 and then activated from the surface 204 once they have reached the desired attachment points 210, 212 relative to the formation 206. When activated, the retention devices 230, 232 attach themselves to the wellbore wall 208 by digging into the rock or other subterranean material by a sufficient amount to provide a long-term, stable attachment. In other embodiments, the cable assembly 200 may be attached to points 215, 217 along the wellbore wall 208 using other suitable attachment or retention devices that provide a stable attachment point to the subterranean material above and below the formation of interest 206.

Generally, during installation, the cable assembly 200 is attached to the retention devices 230, 232 so that the assembly 200 is initially placed under tension. In this manner, the optical cable assembly 200 can detect both a reduction (compaction) and an increase (swelling) of the dimensions of the formation of interest 200. In various embodiments, tension may be achieved by first securing the cable assembly 200 to a first one of the attachment points (e.g., the lower attachment point 212), applying tension to the cable assembly 200, and then securing the cable assembly 200 to the second one of the attachment points (e.g., the upper attachment point 210). In installations where more than two attachment points are used, this process of securing to an attachment point and applying tension can be repeated.

In some embodiments, the attachment points 210, 212 can be implemented using releasable retention devices 230, 232. For instance, the retention devices 230, 232 can include a releasable engagement mechanism 231, 233 (e.g., a latch or releasable lock) that can selectively engage and release the cable assembly 200. The releasable latch or lock 231, 233 can be controlled from either a local power and control source or a remote power and control source that is located, for instance, at the surface 204. The power and control source can be implemented in any of a variety of manners, such as mechanical, electrical, hydraulic, pneumatic, optical, etc. In other embodiments, the releasable engagement mechanism(s) 231, 233 can be configured to respond to control signals in a manner that results in adjustment of the tension applied to the optical cable assembly 200. In this manner, long-term variations in the strain experienced by the optical cable assembly 200 (and thus the strain applied to the optical fiber 214 within the assembly 200) can be limited to a value that is within the safe (reliable) operating range of the optical fiber 214.

In yet other embodiments, rather than using retention devices 230, 232 at selected locations, the entire optical cable assembly 200 may be secured to the wellbore wall 208 using cement. In such embodiments, to ensure that the optical cable assembly 200 is placed under an initial, or baseline, tension, a lower section of the optical cable assembly 200 can be cemented in place first and the cement allowed to cure. Tension can then be applied to the cable assembly 200 while further cement is applied to secure the entire cable assembly 200 along the wellbore wall 208. If desired, varying strengths of cement may be applied to allow for compaction of certain regions of the formation 206 while retaining a firm attachment to the wellbore wall 208 at other locations.

Regardless of the manner of attachment of the optical cable assembly 200 along the wellbore wall 208 to the attachment points 210, 212 above and below the formation of interest 206, in some embodiments, the optical cable assembly 200 can be used to directly monitor dimensional changes within the formation 206 via surface instrumentation 224 that measures changes in optical path length of the section of the fiber 214 between the reference points 215, 217. The surface instrumentation 224 can be configured to implement any of a variety of different optical measurement techniques to monitor optical path length changes, including measuring the strain incident on the optical fiber 214 between reference points 215 and 217 or the optical path imbalance. In addition, the surface instrumentation 224 can implement optical measurement techniques that measure the temperature profile between the reference points 215, 217 so that the measured optical path length changes can be corrected to compensate for variations in temperature between the reference points 215, 217.

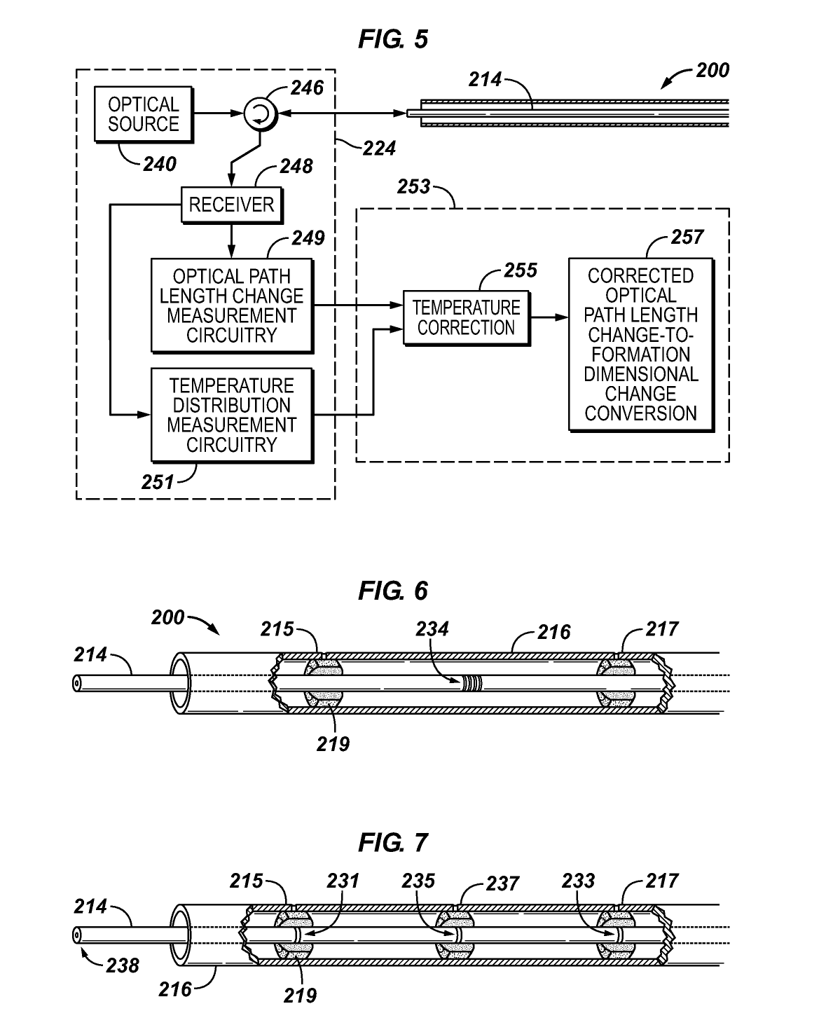

For instance, as shown in FIG. 5, the surface instrumentation 224 can include an optical source 240 (e.g., a laser) to launch an optical signal into the optical fiber 214 of the cable assembly 200. As an example, the optical fiber 214 may include a mirror or other reflector deposited on or attached to its remote end to reflect the launched forward-traveling optical signal. The forward-traveling light is separated from backward-traveling (reflected) light by a circulator 246 that directs light returned from the fiber 214 in response to the optical signal to an optical receiver 248 that converters the optical signal to an electrical signal. The output of the receiver 248 is provided to both to circuitry 249 configured to measure optical path length changes and circuitry 251 that is configured to measure temperature distributions, as will be described in further detail below. In some embodiments, the outputs of circuitry 249 and 251 can be provided to a processing subsystem 253, which includes a temperature correction element 255 to correct the optical path length change measurement to compensate for the effects of temperature. In the embodiment shown, the processing subsystem 253 also includes a conversion module 257 to convert the corrected optical path length change measurement to a dimensional change of the formation 206 based on established relationships between optical path length and the known locations of the attachment points 210, 212 along the wellbore wall 208.

In various implementations, the surface instrumentation system 224 is configured to measure optical path length changes by measuring the strain profile of the optical fiber 214 between the two reference points 215, 217. In exemplary embodiments, the surface instrumentation 224 can be configured to implement Brillouin measurement techniques, such as Brillouin optical time domain reflectrometry (BOTDR) or Brillouin optical time domain analysis (BOTDA) techniques, to measure the strain profile. Changes in the elongation of the fiber 214 (i.e., changes in the optical path length) due to the incident strain can be deduced by integrating the measured strain profile of the fiber 214 between the known reference points 215, 217. When BOTDR is used, the surface instrumentation 224 measures the peak of the Brillouin spontaneous emission. In such an embodiment, the intensity of the spontaneous emission or process linewidth also can be measured by the instrumentation 224 to provide information about the temperature profile between the reference points 215, 217. In embodiments in which BOTDA is used, the surface instrumentation 224 measures the peak frequency of the Brillouin gain spectrum. However, because the Brillouin frequency is strain and temperature dependent, the surface instrumentation 224 is configured to also make an independent measurement of temperature in order to correct the strain measurement for the effects of temperature. The instrumentation 224 can obtain temperature information by measuring the intensity of the Brillouin spontaneous emission using BOTDR. Alternatively, temperature profile information may be derived from other known optical measurement techniques, such as by measuring spontaneous Raman scattering as an example. For the Brillouin measurement techniques, the optical fiber 214 used in the cable assembly 200 can be a single-mode optical fiber, although other types of optical fiber, such as multi-mode fiber may also be employed.

Another optical measurement technique that can be implemented by instrumentation 224 to measure the strain incident along the length of the optical fiber 214 that extends between the reference points 215, 217 involves the use of one or more fiber Bragg gratings (FBGs), such as an FBG 234, which is formed in the fiber 214 between the reference points 215, 217 (see FIG. 6). In general, FBGs are periodic perturbations of the refractive index of the optical fiber that reflect an optical signal strongly at a wavelength that is related to the pitch of the particular grating. As the optical fiber 214 (including the FBG 234) is stretched due to incident strain, the pitch of the grating 234 (along with its refractive index) is altered, resulting in a shift of the wavelength that the FBG reflects. This shift in wavelength can be detected by the surface instrumentation 224 using a variety of commercially available optical interrogation and acquisition systems. In some embodiments, multiple FBGs can be disposed along the length of the fiber 214. As an example, multiple FBGs can be located between the reference points 215, 217. In other embodiments, the fiber 214 may include more than two reference points. In such embodiments, at least one FBG can be interposed between each pair of adjacent reference points. If multiple FBGs are employed, the instrumentation 224 can be configured to interrogate and acquire responses from each of the FBGs disposed along the length of the optical fiber 214 using either known time-domain multiplexing or wavelength-division multiplexing techniques.

FBGs are sensitive to temperature, primarily through the thermo-optic effect. Consequently, the strain measurement obtained by instrumentation 224 also will be temperature-sensitive. Embodiments that employ one or more FBGs to measure the strain profile between the reference points 215, 217 can correct for the temperature sensitivity by configuring the surface instrumentation 224 to also make an independent measurement of the temperature profile between the reference points 215, 217. Again, this measurement may be achieved using Raman distributed temperature sensing, as an example.

Alternatively, the combination of Brillouin frequency measurement and the FBG measurement can be used to correct the strain measurement, because the matrix relating the sensitivities of FBG wavelength and Brillouin frequency to temperature and strain is reasonably well conditioned. In embodiments employing this alternative temperature correction approach, the FBG 234 typically would measure the average strain distribution over the length of the optical fiber 214 between the two reference points 215, 217, but are only locally sensitive to temperature at the location of the FBG 234. In contrast, the Brillouin measurement provides a distribution of frequency that relates to the distribution of both temperature and strain between the reference points 215, 217. The strain can be regarded as uniform over the entire length of the fiber 214 between the reference points 215, 217. Even so, the distributed nature of the Brillouin measurement can provide a compensating measurement local to the FBG 234.

Other embodiments of the dimensional change monitoring techniques and apparatus described herein may implement yet other optical techniques to measure the strain of the optical fiber 214 (and, hence, the change in optical path length between reference points 215, 217). For instance, as shown in FIG. 7, strain measurements can be obtained by incorporating reflectors 231, 233 in the optical fiber 214 at the reference locations 215, 217 and then determining a change in the optical path length of the fiber 214 by measuring the round-trip time of flight of an optical pulse between two such reflectors 231, 233. This measurement may be obtained using a variety of techniques, including frequency-domain and spread-spectrum techniques. However, for purposes of illustration only, a measurement of strain using reflectors 231, 233 will be described herein with reference a surface instrumentation system 224 that is configured to implement time-domain techniques. In this embodiment, an additional reflector 235 is formed in the fiber 214 at reference point 237 to provide for additional resolution of the measurement of the dimensions of the formation of interest 206.

In such an illustrative embodiment, reflectors 231, 233, 235 can be incorporated in to the optical fiber 214 in the form of fiber Bragg gratings that are used purely as reflectors (as opposed to strain sensors where shifts in reflected wavelengths are indicative of strain, as described previously). Other types of suitable reflectors 231, 233, 235 include reflective splices along the length of the fiber 214 at reference points 215, 217, 237 or the incorporation of power splitters at reference points 215, 217, 237 that tap off a portion of the light that launched into and is propagating along the length of the fiber 214. In the latter case, the tap ports for the power splitters incorporate reflectors 231, 233, 235 (e.g., mirrors) to return the light to the launch end 238 of the optical fiber 214.

In embodiments that employ reflectors 231, 233, 235, the optical fiber 214 conceptually can be viewed as being divided into sensitive zones, where each zone is located between a pair of reflectors. The reflectors 231, 233, 235 are located at the reference points 215, 217, 237 where the cable assembly 200 is attached the wall 208 of the wellbore 202, and the zones between reflectors 231, 233, 235 effectively form sensing elements.

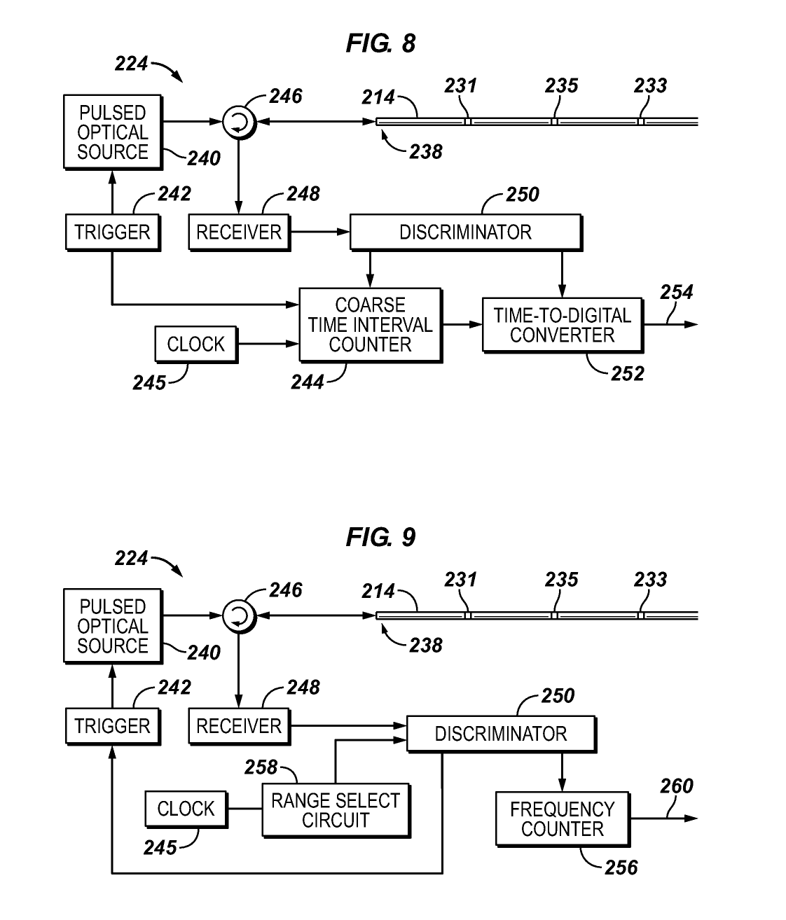

With reference to FIG. 8, an exemplary implementation of the surface instrumentation system 224 is configured to measure the optical path length between reflectors 231, 233, 235 by launching an optical pulse in the launch end 238 of the optical fiber 214 and then observing the time at which each reflected pulse returns to the launch end 238. As shown, the instrumentation system 224 includes the pulsed optical source 240 (e.g., a laser) to generate an optical pulse to be launched into the launch end 238 of the optical fiber 214. A trigger source 242 simultaneously triggers the pulsed laser 240 and starts a counter 244 that provides a coarse measurement of time referenced to a clock 245. As the launched optical pulse propagates along the length of the optical fiber 214, each reflector 231, 233, 235 returns a small fraction of the pulse power (e.g., 1% of the power) to the launch end 238 of the fiber 214.

After separation of forward and backward-traveling light (e.g., by the circulator 246), the returned light is directed to the receiver 248, which converts the optical pulses into electrical pulses. The electrical pulses are then received by a discriminator 250 which converts the analog electrical pulses into digital pulses with a reliable timing relationship between a measure of the arrival time of the analog pulse (e.g., the 50% point on one of its edges or its first moment) and an edge of the digital pulse. The output of the discriminator 250 is used to latch the output of the counter 244 and also to cause a second circuit 252 (i.e., a fine interpolation time-to-digital converter) to provide a digital output 254 dependent on the delay between the latest clock pulse and the output of the discriminator 250. The coarse and the fine delay measuring circuits 244, 252 together provide a high-resolution and wide dynamic range measurement of the propagation delay between the triggering of the optical source 240 and each returned optical signal at the output 254. This arrangement can be configured to measure the reflected light returned from each reflector 231, 233, 235 individually. Alternatively, the arrangement can be configured to latch the output for each reflector 231, 233, 235 and continue to acquire the timing associated with further reflectors. Using a readily available time-to-digital converter 252, a single-shot resolution of 10-20 picoseconds is achievable (corresponding to a round-trip transit time resolution of 1-2 millimetres). Accuracy of the measurements can be further enhanced by averaging successive readings obtained from a particular reflector 231, 233, 235.

The transit time data at output 254 for each reflector 231, 233, 235 can then be subtracted between successive reflectors to determine the optical path length between each pair. Because the optical path length is dependent on both strain and temperature, embodiments of the measurement technique apply a temperature-based correction to the strain measurement to compensate for the effects of temperature. The correction may be achieved by configuring the surface instrumentation 224 to include circuitry 251 that is configured to make any one of the temperature measurements described above.

An alternative arrangement of surface instrumentation 224 for measuring the time of flight of reflected pulses is illustrated in FIG. 9. In this embodiment, the pulsed optical source 240 again is used to launch optical pulses into the launch end 238 of the optical fiber 214. Reflections from the reflectors 231, 233, 235 again are directed to the receiver 248 through the circulator 246 followed by the discriminator 250. Here, however, rather than measuring the time of arrival directly, the output of the discriminator 250 is used to re-trigger the optical source 240, resulting in a periodic pulsing of the optical source 240, the frequency of which can be measured with a frequency counter 256. The frequency provided at the output 260 of the counter 256 is inversely related to the transit time of the pulse to the reflectors 231, 233, 235 and back (with the addition of some overhead in the system instrumentation system 224). In this embodiment, in order to select each reflector 231, 233, 235 in turn, the discriminator 250 can be range-gated with range selection circuitry 258 (which is referenced to the clock 245) to allow reflections to re-trigger the optical source 240 only within a selected time window that corresponds to the approximate location of the reflector 231, 233, 235 that currently is of interest.

Returning now to FIG. 4, yet another exemplary embodiment of an arrangement for determining dimensional changes of the formation of interest 206 is illustrated. In this embodiment, as previously discussed, the optical cable assembly 200 includes the upper section 228 and the lower section 222 that together extend across the formation of interest 206. The upper section 228 is suspended freely from the upper anchor or attachment point 210 so that it extends almost to the lower anchor or attachment point 212, leaving a gap 262 that varies based on the dimensional changes of the formation 206. As shown in FIG. 4, the retention device 230 is secured or attached to the subterranean material (or rock) above the formation of interest 206. The upper section 228 includes a conduit, such as the control line 216, containing the optical fiber 214, which is attached to the retention device 230. The optical fiber 214 is attached to the wall of the tubular conduit 216, such as by any of the attachment techniques that have been previously described herein (e.g., an adhesive 219). The upper section 228 of the assembly 200 thus is suspended and hangs freely within the wellbore 202.

The second lower anchor or attachment point 212 below the formation of interest supports the lower section 222 of the assembly 200. The lower section 222 includes a second conduit 264. The second conduit 264 has a diameter that is different (e.g., smaller) than the diameter of the first conduit 216 so that the first conduit 216 can slide telescopically either inside or outside of the second conduit 264. The reflector 226 (e.g., a mirror, corner cube, etc.) is fixed inside of the second conduit 264 at the reference point 217. This reflector 226 reflects light arriving from above from the upper section 228. The optical fiber 214 within the first conduit 216 can be terminated with a lens arrangement 266 that collimates the light (as illustrated by the dotted lines) emerging from remote end 268 of the optical fiber 214 to direct it to the reflector 226. The lens arrangement 266 also collects and re-launches into the optical fiber 214 light that is reflected from the reflector 226.

In this embodiment, light that is launched from the surface instrumentation 224 propagates to the remote end 268 of the optical fiber 214. A portion of the light that arrives at the remote end 268 of the optical fiber 214 is reflected back to the launch end 238 of the optical fiber 214. Another portion of the launched light emerges from the remote end 268 and is incident on the reflector 266 in the second conduit 264. The reflector 266 reflects the light back to the optical fiber 214 where it propagates to the launch end 238 for detection by instrumentation system 224.

A dimensional change in the formation 206 shown in FIG. 4 is transferred to a change in the distance between the remote end 268 of the optical fiber 214 (which acts as a reflector) and the reflector 226 contained within the second conduit 264. This distance can be measured by the surface instrumentation 224 using a variety of techniques. An example of one such technique employs low-coherence reflectometry which employs a broadband (thus having a short coherence length) optical source and a matched interferometer. The interferometer is adjusted in its path imbalance until interference fringes appear. When this occurs, the path imbalance in the interferometer matches the optical path length between the remote end 268 of the optical fiber 214 and the reflector 266 in the second conduit 264. Changes in the path imbalance are thus indicative of changes in the size of the gap 262 and, consequently, changes in the optical path length between reference points 215 and 217. The optical path length change, in turn, is indicative of a dimensional change within the formation 206.

The path imbalance measurement itself is not temperature sensitive and, thus, does not require temperature compensation. However, temperature correction of the measurement may still be implemented to compensate for the expansion effects (and changes in the refractive index) in the length of the optical fiber 214 that extends between the upper attachment point 210 and the remote end 264 of the fiber 214. Again, a measurement of the temperature profile along this length of the optical fiber 214 may be obtained by employing any of the distributed temperature measurement techniques described above.

As discussed above, the various measurements of optical path length benefit from temperature compensation to correct the measured parameter to cancel the effect of temperature changes between the reference points. In the case of the strained fiber techniques described above, the purpose of the correction is to separate the effects of temperature from those of strain, since the parameters that are measured are generally dependent on both temperature and strain. In the case of the suspended fiber arrangement shown in FIG. 4, the correction is applied to account for the thermal expansion of the optical fiber 214 (and, usually just as importantly, its coating).

The temperature-corrected optical path length change measurement is a direct indicator of a change in the distance between the reference points 215, 217. When these reference points 215, 217 are attached to the wellbore wall 208 at attachment points on either side of the formation (or portion of the formation) of interest 206, the optical path length change measurement is a direct indicator of a dimensional change (e.g., thickness) within the formation 206.

In various embodiments, the surface instrumentation 224 can include all or part of the processing subsystem 253 that corrects the optical path length measurements and converts the corrected optical path length measurements to dimensional changes using known relationships between the measured parameter (e.g., Brillouin frequency, flight time, path imbalance) and distance. In other embodiments, the processing subsystem 253 may be at a location remote from the wellbore 202. In other embodiments, the optical path length change may be converted to dimensional changes of the formation 206 by an operator or user having access to the measurements obtained by the surface instrumentation system 224.

In some embodiments, the systems and techniques described herein may be employed in conjunction with an intelligent completion system disposed within a well that penetrates a hydrocarbon-bearing earth formation. Portions of the intelligent completion system may be disposed within cased portions of the well, while other portions of the system may be in the uncased, or open hole, portion of the well. The intelligent completion system may comprise one or more of various components or subsystems, which include without limitation: casing, tubing, control lines (electric, fiber optic, or hydraulic), packers (mechanical, sell or chemical), flow control valves, sensors, in flow control devices, hole liners, safety valves, plugs or inline valves, inductive couplers, electric wet connects, hydraulic wet connects, wireless telemetry hubs and modules, and downhole power generating systems. Portions of the systems that are disposed within the well may communicate with systems or sub-systems that are located at the surface. The surface systems or sub-systems in turn may communicate with other surface systems, such as systems that are at locations remote from the well.

It should be understood that embodiments of the invention are not limited to monitoring dimensional changes of subterranean, hydrocarbon-producing formations as shown in the illustrative examples. For instance, the fiber optic monitoring systems and techniques described herein can also be employed to monitor dimensional changes of other types of geological features (e.g., faults) which may be located either above or below the earth surface. It should also be understood that when used to monitor dimensional changes within hydrocarbon-producing formations, embodiments of the invention are not limited to the well structures shown in the illustrative examples. Cased, uncased, open hole, gravel packed, deviated, horizontal, multi-lateral, deep sea or terrestrial surface injection and/or production wells (among others) may incorporate a fiber optic formation dimension monitoring system as described. In many applications, the measurements of the dimensional changes of the hydrocarbon-producing formation may provide useful information that may be used to monitor and assure the stability of surface installations above the reservoir. For instance, the measurements may provide an indication of the onset of heave or subsidence that may affect the safety of personnel and equipment in the vicinity of the well. This information then can be used to take proactive measures to prevent damage, injury, or threats to the stability of the installation. As examples, reservoirs can suffer from subsidence after sustained production over an extended time and from water injected into the formation that dissolves the chalk (or other material) forming the reservoir. In the case of steam-assisted oil recover, the heating of the reservoir can lead to expansion and, thus, to heave at the surface. In addition, the information gained from the measurements can be used to validate and improve models of reservoir drainage, including geomechanical models that facilitate optimization of the extraction from the reservoir.

While the invention has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the invention.

What is claimed is:

1. A method of measuring a dimensional change of a geological feature, comprising:
measuring a change in length of an optical path between first and second reference points of a fiber optic sensor assembly deployed along the geological feature, the first reference point of the fiber optic sensor assembly fixed at a first location relative to the geological feature and the second reference point of the fiber optic sensor assembly fixed at a second location relative to the geological feature; and
determining a dimensional change of the geological feature based on the measured change in length of the optical path between the first and second reference points.

2. The method as recited in claim 1, further comprising measuring a distribution of temperature along the optical path between the first and second reference points.

3. The method as recited in claim 2, further comprising correcting the measured change in length of the optical path based on the measured distribution of temperature, wherein the dimensional change is determined based on the corrected measured change in length of the optical path.

4. The method as recited in claim 3, wherein measuring the change in length of the optical path comprises measuring the strain incident on the optical fiber between the first and second reference points.

5. The method as recited in claim 1, wherein the geological feature is a subterranean formation, and further comprising deploying the fiber optic sensor assembly into a wellbore that penetrates the subterranean formation, fixing the first reference point of the fiber optic sensor assembly to the wellbore wall at the first location, and fixing the second reference point of the fiber optic sensor assembly to the wellbore wall at the second location.

6. The method as recited in claim 5, further comprising applying tension to the fiber optic assembly prior to attaching at least one of the first reference point at the first location and the second reference point at the second location.

7. The method as recited in claim 5, wherein the fiber optic sensor assembly includes an optical fiber having a first reflector disposed along its length, and wherein measuring the change of length of the optical path comprises launching an optical signal into the optical fiber, and detecting reflected light returned from the first reflector in response to the launched optical signal.

8. The method as recited in claim 7, wherein the first reflector is disposed at the first reference point of the optical fiber and a second reflector is disposed at the second reference point of the optical fiber, and wherein measuring the change of length of the optical path comprises detecting reflected light returned from the first and second reflectors in response to the launched optical signal, and determining a time of flight between the launching of the optical signal and the detection of the reflected light.

9. The method as recited in claim 5, wherein the fiber optic sensor assembly includes an optical fiber having a fiber Bragg grating disposed along its length, the fiber Bragg grating configured to reflect an optical signal at a particular wavelength, and wherein measuring the change of the optical path length comprises launching an optical signal into the optical fiber, and detecting a shift in the particular wavelength reflected by the fiber Bragg grating in response to the optical signal, wherein the shift is indicative of a dimensional change within the formation.

10. The method as recited in claim 5, wherein the fiber optic sensor assembly includes a first section and a second section, the first section movable relative to the second section, the first section including an optical fiber attached to the first reference point and having a free end, the second section including a reflector disposed at the second reference point such that a gap is present between the free end and the reflector, and wherein measuring the change of length of the optical path comprises detecting a change in the gap between the free end and the reflector, wherein the change in the gap is indicative of a dimensional change within the formation.

11. A fiber optic monitoring system for measuring a dimensional change within a subterranean formation, comprising:
a fiber optic cable assembly deployed in a wellbore that penetrates a subterranean formation, the fiber optic cable assembly comprising a conduit, an optical fiber disposed within the conduit, wherein the conduit is attached to a wall of the wellbore at a first attachment location above the subterranean formation and at a second attachment location below the subterranean formation; and
a fiber optic monitoring system to launch optical signals into the optical fiber, to detect returned optical signals generated by the optical fiber in response to the launched optical signals, and to measure a change in length of the optical path between the first and second attachment locations based on the detected returned optical signals, wherein the change in optical path length is indicative of a dimensional change within the subterranean formation.

12. The system as recited in claim 11, wherein the optical fiber is attached to the conduit at a first reference location that corresponds to the first attachment location.

13. The system as recited in claim 12, wherein the optical fiber is attached to the conduit at a second reference location that corresponds to the second attachment location.

14. The system as recited in claim 13, wherein fiber optic monitoring system measures strain incident on the optical fiber between the first and second reference locations, wherein the measured strain is indicative of the change in the optical path length.

15. The system as recited in claim 14, wherein the optical fiber includes a first reflector at the first reference location and a second reflector at the second reference location, wherein the fiber optic measurement system measures the strain based on a measured time of flight between launch of the optical signal and detection of respective returned optical signals from the first reflector and the second reflector.

16. The system as recited in claim 11,
wherein the conduit comprises a first conduit section attached to the first attachment point and a second conduit section attached to the second attachment point, the second conduit section including a reflector disposed at a location that corresponds to the second attachment point,
wherein the optical fiber is attached to the first conduit section at a location that corresponds to the first attachment point and has a remote end located so that a gap is present between the remote end and the reflector,
wherein the first conduit section is movable relative to the second conduit section to change the gap between the terminal end of the optical fiber and the reflector in response to a dimensional change within the formation, and
wherein the fiber optic monitoring system is configured to measure the change in the gap.

17. The system as recited in claim 11, wherein the fiber optic monitoring system is further configured to measure a temperature distribution between the first and second attachment locations based on the detected returned optical signals and to correct the measured change in optical path length based on the measure temperature distribution.

18. The system as recited in claim 17, wherein the fiber optic monitoring system measures the change in optical path length by determining strain incident on the optical fiber between the first and second attachment points.

19. A fiber optic monitoring system for measuring a dimensional change of a geological feature, comprising:
a fiber optic cable assembly that extends between first and second opposing sides of a geological feature, the fiber optic cable assembly comprising a conduit, an optical fiber disposed within the conduit, wherein the conduit is attached at a first attachment point on the first side of the geological feature and at a second attachment point on the second side of the geological formation; and
a fiber optic monitoring system to launch optical signals into the optical fiber, to detect returned optical signals generated by the optical fiber in response to the launched optical signals, and to measure a change in length of the optical path between the first and second attachment locations based on the detected returned optical signals, wherein the change in optical path length is indicative of a dimensional change of the geological feature.

20. The fiber optic monitoring system as recited in claim 19, wherein the geological formation is a hydrocarbon-producing formation, wherein the fiber optic cable assembly is deployed in a wellbore that penetrates the hydrocarbon-producing formation, and wherein the first and second attachment points are located along a wall of the wellbore.
